(19) United States
(12) Patent Application Publication
(10) Pub. No.: US 2019/0014950 A1
(43) Pub. Date: Jan. 17, 2019

(54) DISPOSABLE FOOD OR WASTE TONGS

(71) Applicant: Seong deok JEONG, Gangwon-do (KR)

(72) Inventor: Seong deok JEONG, Gangwon-do (KR)

(21) Appl. No.: 15/707,329

(22) Filed: Sep. 18, 2017

(30) Foreign Application Priority Data
Jul. 14, 2017 (KR) 20-2017-0003683

(51) Int. Cl. A47J 43/28; A41D 19/02; A41D 19/015; B25B 9/02

(52) U.S. Cl. CPC A47J 43/283; A41D 19/02; A41D 2400/20; B25B 9/02; A41D 2300/24; A41D 19/01547

(57) ABSTRACT

Disclosed herein are disposable food or waste tongs. The disposable food or waste tongs include a first thimble configured to provide a space adapted to receive a finger, and a third thimble located in a direction opposite to the first thimble. Each of the thimbles has a trapezoidal shape whose width decreases toward a front end thereof when viewed in a plan view and has a side whose height increases in an inward from the front end. A first band is formed to surround the outside of the rear portion of the first thimble, and a third band is formed to surround the outside of the rear portion of the third thimble. Extension portions configured to support the lower portions of fingers or a palm are formed adjacent to the first thimble and the third thimble, respectively.

### BACKGROUND

### 1. Technical Field

The present invention relates generally to disposable food or waste tongs. More specifically, the present invention relates to disposable food or waste tongs which are sturdy and convenient.

### 2. Description of the Related Art

It is unsanitary to treat food or waste with a bare hand. Even when a glove is used, the glove is easily soiled, and it is burdensome to clean the glove. Although disposable vinyl gloves are used, the material thereof is slippery and wasted because the disposable vinyl gloves cover an overall hand, the disposable gloves are unsanitary because there are many cases where the disposable vinyl gloves are used for long periods of time without replacement, and there is concern that a skin disease, such as eczema, occurs in the finger because moisture infiltrates into the disposable vinyl gloves.

The present inventor proposed disposable food tongs in Korean Utility Model Registration No. 20-0482486. When a user touches food, the disposable food tongs are worn on the middle finger, index finger and thumb of the user, thereby preventing the food from coming into direct contact with the fingers. Furthermore, the disposable food tongs are provided with ring portions configured to surround the middle and index fingers of the user in a dual manner.

Although the above disposable food tongs have a desirable function, they are problematic in that the structure and fabrication thereof are somewhat complex. The present invention provides disposable food or waste tongs which are made more sturdy and convenient by improving the above disposable food tongs.

### SUMMARY

An object of the present invention is to provide disposable food or waste tongs which are convenient to fabricate, are simple to use, and have desirable durability.

In order to accomplish the above object, according to an embodiment of the present invention, there is provided a blank for the fabrication of disposable food or waste tongs, the blank including: a first support portion, a base portion disposed at an opposite location in a direction opposite to the first support portion, and trapezoidal first and third covers disposed adjacent to the first support portion and the base portion, respectively, with fold lines used as boundaries; wherein side flaps configured such that the tops thereof are streamlined and inclined downward are disposed on both sides of the first support portion with fold lines used as boundaries, rectangular band flaps configured to extend downward are disposed on both sides of the first support portion with cut lines used as boundaries, and a fold line is located at a boundary between each of the side flaps and each of the band flaps; wherein third side flaps configured such that the lower portions thereof are streamlined and inclined upward are disposed on both sides of the base portion with fold lines used as boundaries, rectangular third band flaps configured to extend upward are disposed on both sides of the base portion with cut lines used as boundaries, and a fold line is located at a boundary between each of the third side flaps and each of the third band flaps; and wherein the band flaps on both sides of the first support portion are connected to each other, and the third band flaps on both sides of the base portion are connected to each other, thereby forming respective bands.

The blank may further include a second support portion configured to be disposed adjacent to the first support portion in a direction identical to that of the first support portion and to have a structure identical to that of the first support portion, side flaps, and band flaps.

In order to accomplish the above object, according to another embodiment of the present invention, there is provided a blank for the fabrication of disposable food or waste tongs, the blank including: a trapezoidal support portion, and a cover portion configured to be symmetrical to the support portion with respect to a fold line; wherein a first band flap is formed above the cover portion with a central fold line and both side cut lines as boundaries; wherein second band flaps are formed on both sides of the cover portion with cut lines and a fold line as continuous boundaries; and wherein fold lines are formed on both sides of the first band flap, and fold lines are formed in the lower portions of both sides of the second band flap, thereby forming a first band and a second band.

In order to accomplish the above object, according to still another embodiment of the present invention, there are provided disposable food or waste tongs which are fabricated using the blank.

In order to accomplish the above object, according to yet another embodiment of the present invention, there are provided disposable food or waste tongs, including: a first thimble configured to provide a space adapted to receive a finger, and a third thimble located in a direction opposite to the first thimble; wherein each of the thimbles has a trapezoidal shape whose width decreases toward a front end thereof when viewed in a plan view and has a side whose height increases in an inward from the front end; wherein a first band is formed to surround the outside of the rear portion of the first thimble, and a third band is formed to surround the outside of the rear portion of the third thimble; and wherein extension portions configured to support the lower portions of fingers or a palm are formed adjacent to the first thimble and the third thimble, respectively.

A second band may be formed behind the first band of the first thimble, a second band may be formed behind the third band of the third thimble, and ventilation openings may be formed through the sides of the first and third thimbles.

The disposable food or waste tongs may further include a second thimble configured to be identical to the first thimble and to be disposed adjacent to the first thimble in a direction identical to a direction in which the first thimble is disposed.

The disposable food or waste tongs may further include guides formed on both sides of the extension portions adjacent to the first and third thimbles and configured to support and guide fingers.

### BRIEF DESCRIPTION OF THE DRAWINGS

The above and other objects, features and advantages of the present invention will be more clearly understood from the following detailed description taken in conjunction with the accompanying drawings, in which:

FIG. 1a is a plan view showing a blank which is used to fabricate disposable food or waste tongs according to an embodiment of the present invention;

FIG. 1b is a perspective view showing a state in which the covers and flaps of FIG. 1a have been cut along the cut lines and/or turned along the fold lines;

FIG. 1c is a perspective view showing a state in which the first band flap of FIG. 1b erected along the fold line and turned along the fold line and the second band flap of FIG. 1b erected along the fold line and turned along the fold line are disposed opposite to each other;

FIG. 1d is a perspective view showing the disposable food or waste tongs according to the embodiment of the present invention, which is completed via the assembly process of FIGS. 1a to 1c;

FIG. 2a is a perspective view showing disposable food or waste tongs according to another embodiment of the present invention;

FIG. 2b is a view showing an embodiment which is similar to the embodiment of FIG. 2a except that the width of the first thimble is expanded;

FIG. 2c is a perspective view showing disposable food or waste tongs according to a modification of FIG. 2a;

FIG. 3a is a plan view showing a blank which is used to fabricate disposable food or waste tongs according to still another embodiment of the present invention;

FIG. 3b is a perspective view showing the disposable food or waste tongs according to the embodiment of the present invention, which is fabricated based on the blank of FIG. 3a; and

FIG. 4 is a perspective view showing disposable food or waste tongs according to yet another embodiment of the present invention.

### DETAILED DESCRIPTION

The advantages, features, and aspects of the present invention will become apparent from the embodiments which will be described in detail below in conjunction with the accompanying drawings. However, the present invention is not limited to the embodiments disclosed below, but may be implemented in various different forms. In the following description of the present invention, when it is determined that a detailed description of a related well-known function or configuration may make the gist of the present invention obscure, the detailed description will be omitted.

Throughout the specification, when a specific portion is described as including a specific component, this does not mean that the portion excludes another component, but means that the portion may include another component, unless otherwise specified.

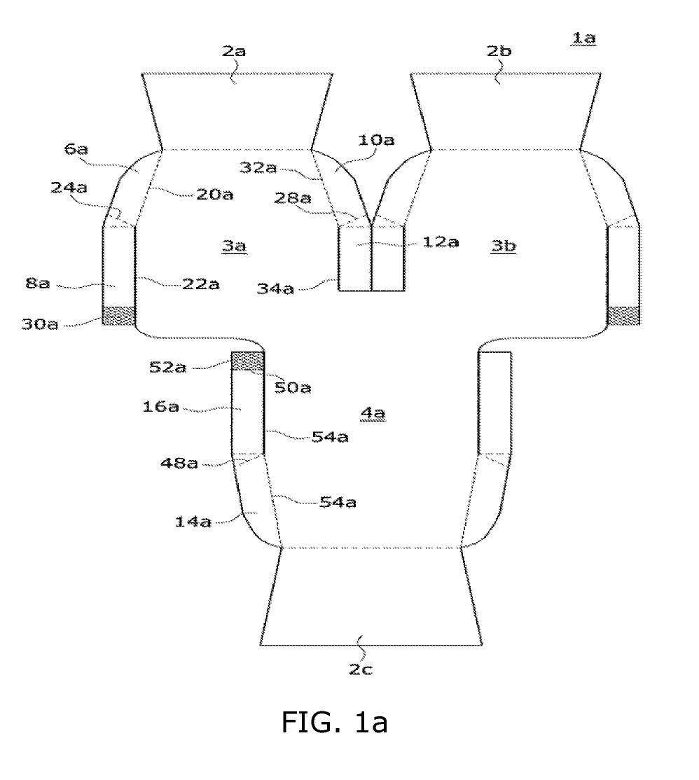

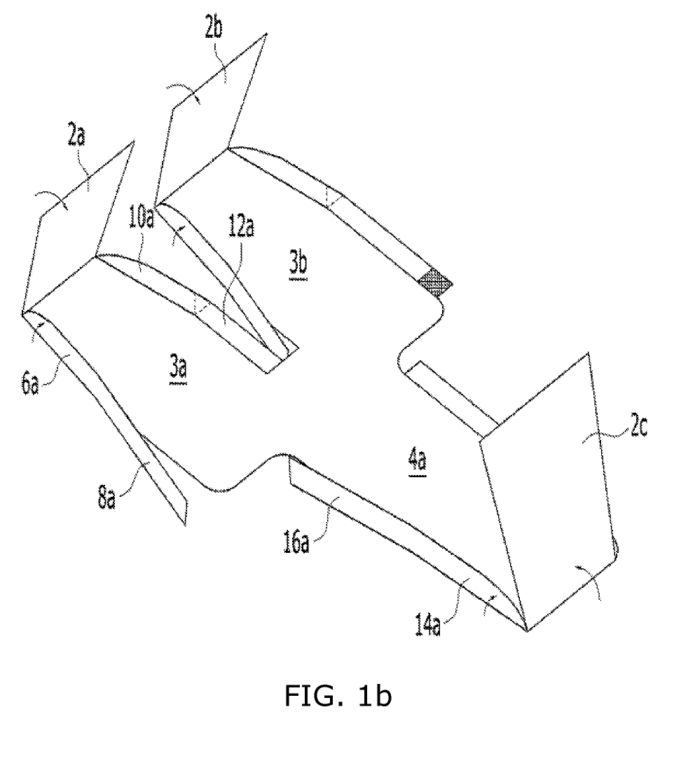

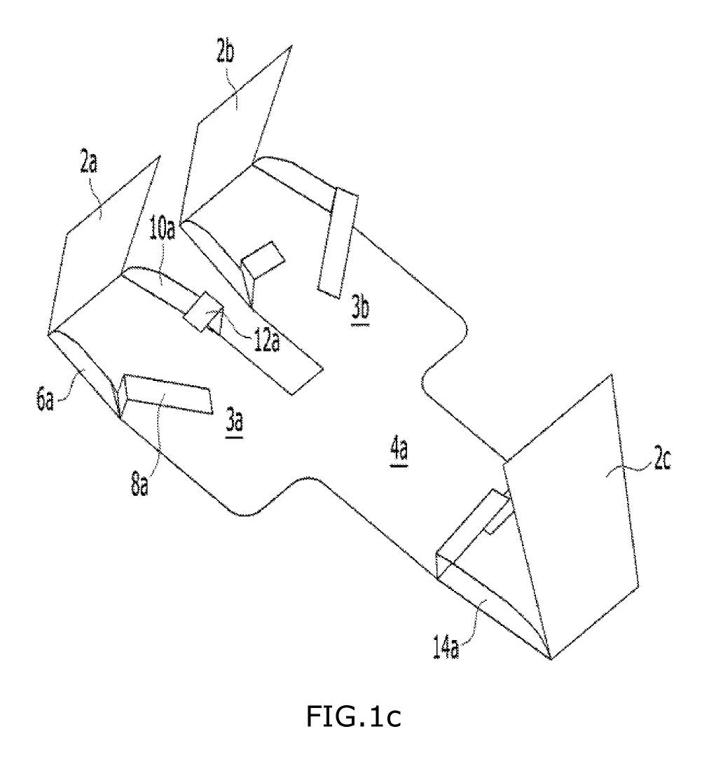

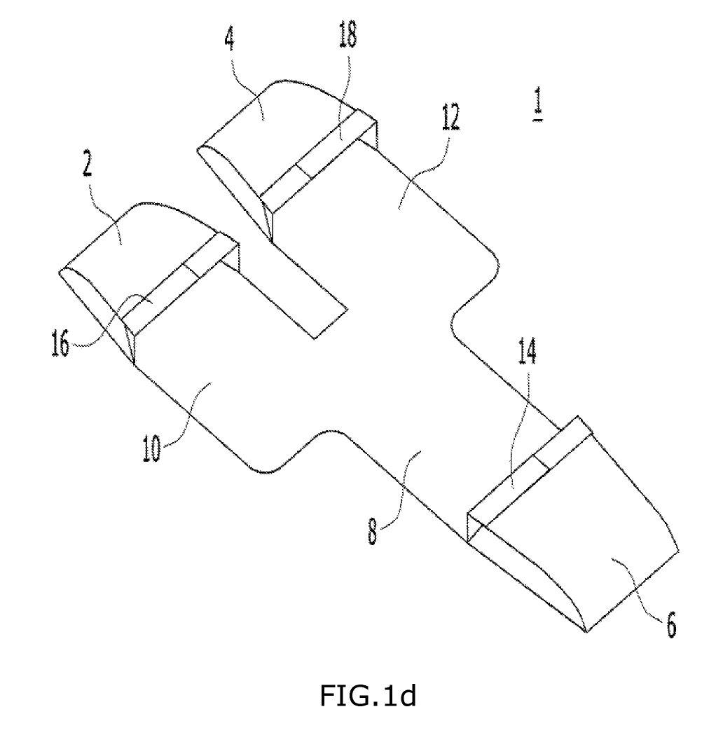

FIG. 1a shows a blank 1a which is used to fabricate disposable food or waste tongs 1 according to an embodiment of the present invention. The blank 1a is made of foldable flat material, such as paper or soft plastic.

The blank 1a includes a first support portion 3a, a second support portion 3b, and a base portion 4a configured such that the first and second support portions 3a and 3b are branched off therefrom. Trapezoidal first, second and third covers 2a, 2b and 2c are respectively disposed adjacent to the first support portion 3a, the second support portion 3b, and the base portion 4a along respective fold lines. Since the first support portion 3a and its related member are symmetrical to the second support portion 3b and its related member, the following description will be given with a focus on the first support portion 3a.

It should be noted that in the following description, the terms “first,” “second,” “third,” etc. do not mean that the locations of elements have been set, but are used merely to distinguish the elements from other elements in each embodiment for ease of description.

A first side flap 6a configured such that the top thereof is streamlined and inclined downward is disposed on the left side of the first support portion 3a with a fold line 20a used as a boundary, and a rectangular first band flap 8a configured to extend downward is disposed on the left side of the first support portion 3a with a cut line 22a used as a boundary.

A lateral fold line and an inclined fold line 24a configured to extend from the lateral fold line are located between a boundary region between the first side flap 6a and the first band flap 8a. An adhesive region 30a is located in the bottom portion of the first band flap 8a.

A second side flap 10a configured such that the top thereof is streamlined and inclined downward is disposed on the right side of the first support portion 3a with a fold line 32a used as a boundary, and a rectangular second band flap 12a configured to extend downward is disposed on the right side of the first support portion 3a with a cut line 34a used as a boundary.

A lateral fold line and an inclined fold line 28a configured to extend from the lateral fold line are located in a boundary region between the second side flap 10a and the second band flap 12a.

Configurations adjacent to the base portion 4a are symmetrical and similar to the configurations adjacent to the first support portion 3a. In other words, a third side flap 14a configured such that the bottom thereof is streamlined and inclined downward is disposed on the left side of the base portion 4a with a fold line 54a used as a boundary, and a rectangular third band flap 16a configured to extend upward is disposed on the left side of the base portion 4a with a cut line 54a used as a boundary.

A lateral fold line and an inclined fold line 48a configured to extend from the lateral fold line are located in a boundary region between the third side flap 14a and the third band flap 16a. An adhesive region 52a is located on the top portion of the third band flap 16a.

A structure on the right side of the base portion 4a is the same as that on the left side of the base portion 4a.

FIG. 1b is a perspective view showing a state in which the covers and flaps of FIG. 1a have been cut along the cut lines and/or turned along the fold lines.

FIG. 1c is a perspective view showing a state in which the first band flap 8a of FIG. 1b erected along the fold line 24a and turned along the fold line 26a and the second band flap 12a of FIG. 1b erected along the fold line 28a and turned along the fold line 36a are disposed opposite to each other. Since the two band flaps have the same shape but the first band flap 8a further includes the adhesive region 30a, the two band flaps can be adhered to each other via the adhesive region 30a, thereby forming a band. The band flaps are turned and adhered to each other above the top surface of the first cover 2a. In the same manner, the band flaps are turned and adhered to each other above the corresponding cover in each of the second support portion 3b and the base portion 4a.

FIG. 1d is a perspective view showing the disposable food or waste tongs 1 according to the embodiment of the present invention, which is completed via the above-described assembly process.

The tongs 1 include a first thimble 2, a second thimble 4, and a third thimble 6. Each of the thimbles has a trapezoidal shape whose width decreases toward the front end thereof when viewed in a plan view. Furthermore, as a result of each of the side flaps 6a, 10a and 14a being inclined to be streamlined, the side of the thimble is formed to have a height which increases in an inward direction from the front end thereof. Accordingly, spaces formed by the thimbles are convenient to insert fingers of a human, and are suitable to move fingers therein.

A first band 16 formed in the first thimble 2, a first band 18 formed in the second thimble 4, and a first band 14 formed in the third thimble 6 function to impart sturdiness to the thimbles, to prevent the thimbles from being damaged, and to maintain the shapes of the thimbles.

An approximately rectangular first extension portion 10, an approximately rectangular second extension portion 12, and an approximately rectangular third extension portion 8 are formed adjacent to the first thimble 2, the second thimble 4, and the third thimble 6.

The index finger may be inserted into the first thimble 2, the middle finger may be inserted into the second thimble 4, and the thumb may be inserted into the third thimble 6. The extension portions 8, 10 and 12 function to support the lower portions of the fingers or the palm.

The disposable food or waste tongs 1 according to the embodiment of the present invention has the advantage of being manufactured in quantity based on blanks made of paper or soft plastic.

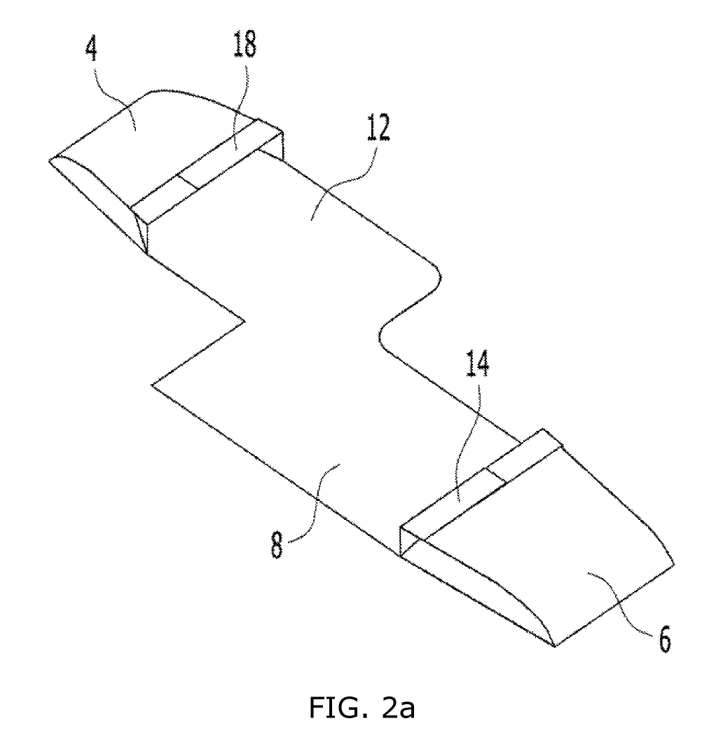

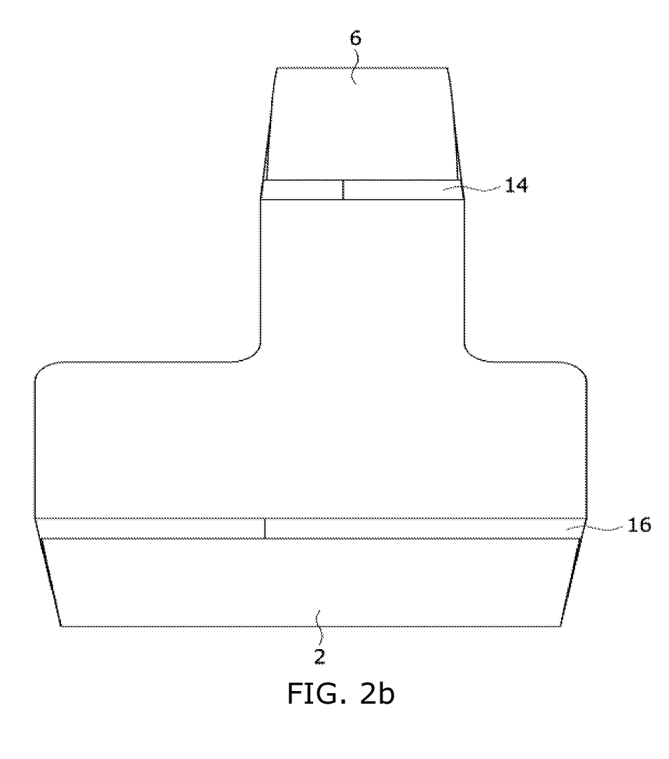

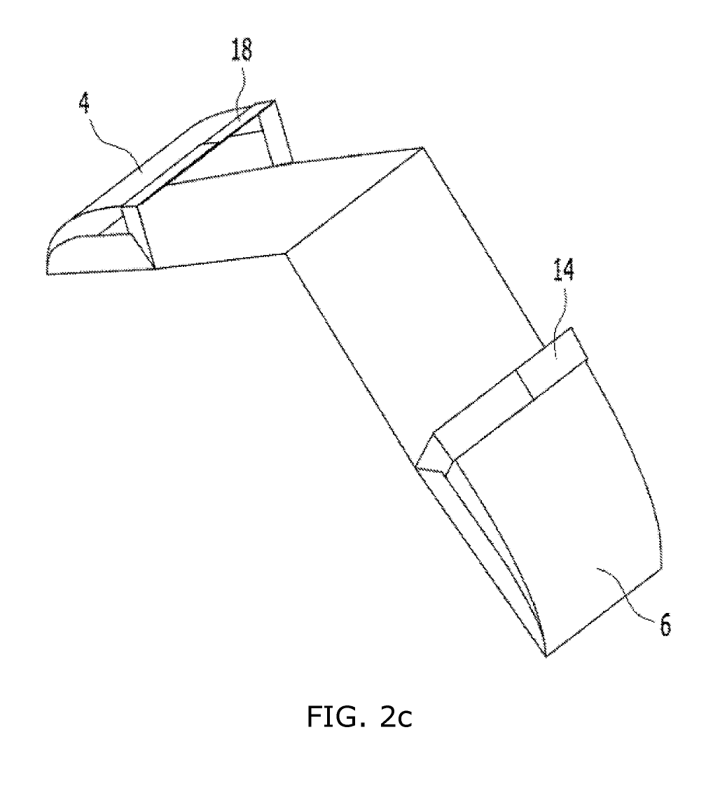

FIG. 2a is a perspective view showing disposable food or waste tongs 1 according to another embodiment of the present invention. This embodiment is the same as the previous embodiment except that the first thimble 2 has been eliminated. In this case, the disposable food or waste tongs 1 may be used with two fingers inserted into a second thimble 4 and a third thimble 6. Alternatively, the second thimble 4 may be eliminated, and the first thimble 2 and the third thimble 6 may be left. The embodiment of FIG. 2a is very useful for, for example, a case where the thumb and the index finger are used.

Alternatively, as shown in FIG. 2c, the third thimble 6 and the second thimble 4 may be disposed in the same lengthwise direction. This modification is particularly useful for a case where a finger, particularly the thumb, and the middle finger are spread to form the shape of tongs and then used.

The embodiment of FIG. 2b is similar to the embodiment of FIG. 2a except that the width of the first thimble 2 is expanded. Accordingly, for example, four fingers exclusive of the thumb may be inserted into the first thimble 2. This embodiment is advantageous in that force can be applied to the treatment of food or waste by using all the fingers of a hand.

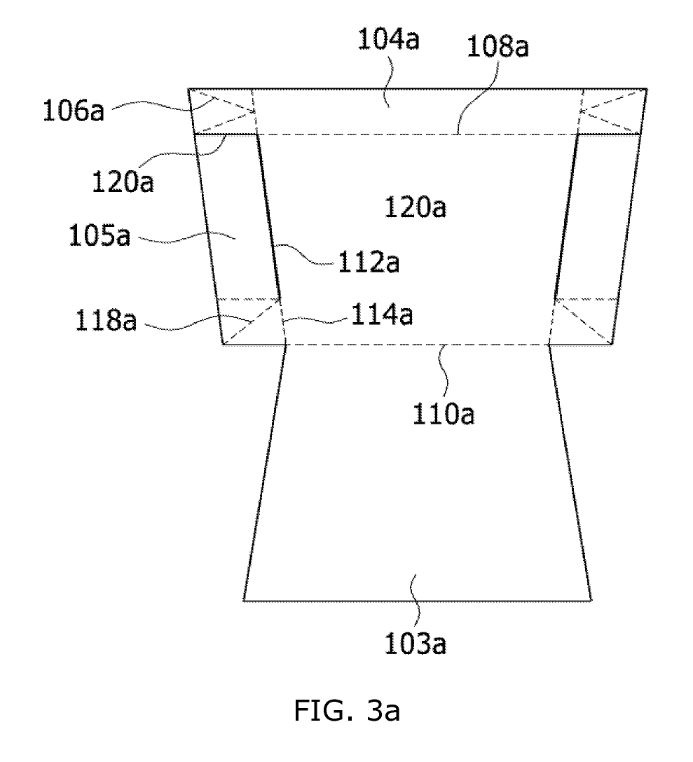

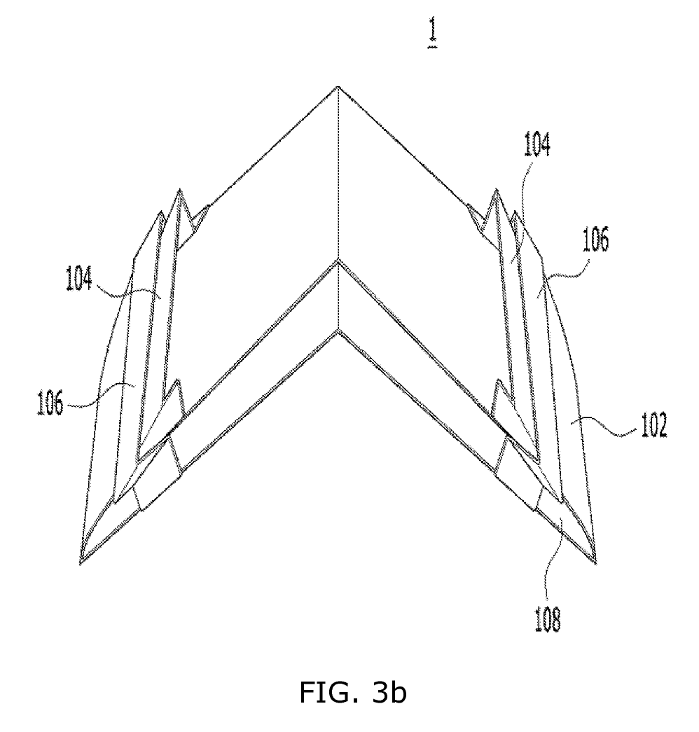

FIG. 3a shows a blank 1a which is used to fabricate disposable food or waste tongs 1 according to still another embodiment of the present invention. The blank 1a is made of a foldable flat material, such as paper or soft plastic. This embodiment is different from the previous embodiments in that two bands are formed for a single thimble and thus strength is enhanced.

The blank 1a includes a trapezoidal support portion 103a and a cover portion 120a symmetrical to the support portion 103a with respect to a fold line 110a. A first band flap 104a is formed in the top portion of the cover portion 120a with a central fold line 108a and side cut lines 112b as boundaries, and a second band flap 105a is formed on each of both sides of the cover portion 120a with a cut line 112a and a fold line 114a used as boundaries. Fold lines 106a are formed on both sides of the first band flap 104a, and lateral and inclined fold lines 118a are formed in the bottom portion of each of the second band flaps 105a.

In this state, both the side second band flaps 105a are separated along the cut lines 112b and the cut lines 112a exclusive of the fold lines 114a, and the first band flap 104a is turned along the fold line 108a in an outer direction, i.e., in a direction toward a ground surface. Thereafter, the cover portion 120a is turned along the fold line 110a in an inward direction, i.e., in a direction away from the ground surface. By doing so, the overall frame of a thimble 102 and a first band 104 is completed. Thereafter, when both the side second band flaps 105a are erected along the fold lines 118a and turned over the top of the cover portion 120a, both ends of the second band flaps 105a are brought into contact with each other, and are adhered to each other by an adhesive applied to an adhesive region (not shown), thereby completing a second band 106. The second band 106 is located immediately behind the first band 104.

FIG. 3b is a perspective view showing the disposable food or waste tongs 1 according to the embodiment of the present invention, which is completed by the above-described assembly process. The first band 104 and the second band 106 are formed behind the thimble 102. It will be apparent that the first band 104 has a single layer structure and the second band 106 has a two-layer structure extending from the bottom surface of the thimble 102. Since the embodiment of FIG. 3a does not include side flaps unlike the previous embodiments, openings 108 configured to perform ventilation are formed through the sides of the tongs 1.

FIG. 3b shows a case where a thimble 102 and another thimble symmetrical in location and shape to the thimble 102 are formed, i.e., a case where two fingers are used, for ease of illustration. However, this is merely an example. Accordingly, it will be apparent that the dual band structure may be applied not only to the embodiment of FIG. 2a but also to the embodiment of FIG. 1d using three fingers and the embodiment of FIG. 2c using five fingers, without significantly change.

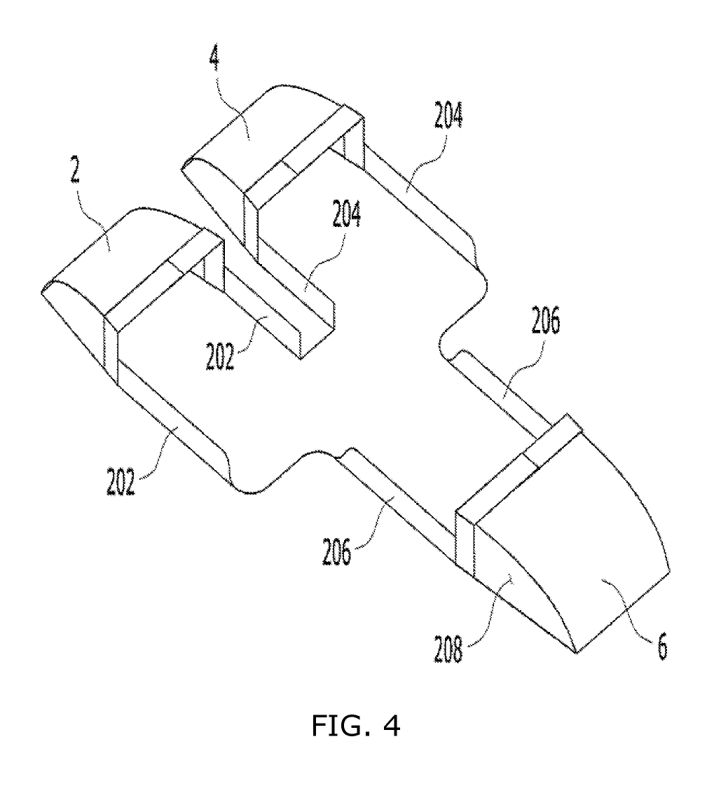

FIG. 4 is a perspective view showing disposable food or waste tongs 1 according to yet another embodiment of the present invention.

Although the tongs 1 are fabricated using a blank 1a which is basically similar to the blank 1a of FIG. 1a, the former blank 1a is different from the blank 1a of FIG. 1a in that a first band flap 8a is located in an upper portion and a reinforced flap similar in shape to and different in function from the first side flap 6a is located in a lower portion, on the left side of the first support portion 3a.

In this case, although the tongs 1 are similar to the tongs of FIG. 1d, the tongs 1 are different from the tongs of FIG. 1d in that a first thimble 2, a second thimble 4 and a third thimble 6 provide erected guides 202, 204 and 206 and an opening 208 configured to perform ventilation is formed through each of the thimbles because there are no side flaps. This structure has the advantage of guiding and supporting the portions of the fingers which are not inserted into thimbles.

It will be understood by those skilled in the art that a guide structure, such as that of FIG. 4, may be applied to the embodiments shown in FIGS. 2 and 3.

According to the present invention, there can be provided the disposable food or waste tongs which are convenient to fabricate, are simple to use, have desirable durability, and are sanitary.

According to the present invention, there can be provided the disposable food or waste tongs which can be manufactured in quantity based on blanks.

Although the specific embodiments of the present invention have been described above, the present invention may be implemented in various different forms. The embodiments have been provided merely to complete the disclosure of the present invention and to enable those having ordinary knowledge in the art to which the present invention pertains to completely understand the scope of the invention, and the present invention is defined only by the attached claims.

1. A blank for fabrication of disposable food or waste tongs, the blank comprising:
a first support portion, a base portion disposed at an opposite location in a direction opposite to the first support portion, and trapezoidal first and third covers disposed adjacent to the first support portion and the base portion, respectively, with fold lines used as boundaries;
wherein side flaps configured such that tops thereof are streamlined and inclined downward are disposed on both sides of the first support portion with fold lines used as boundaries, rectangular band flaps configured to extend downward are disposed on both sides of the first support portion with cut lines used as boundaries, and a fold line is located at a boundary between each of the side flaps and each of the band flaps;
wherein third side flaps configured such that lower portions thereof are streamlined and inclined upward are disposed on both sides of the base portion with fold lines used as boundaries, rectangular third band flaps configured to extend upward are disposed on both sides of the base portion with cut lines used as boundaries, and a fold line is located at a boundary between each of the third side flaps and each of the third band flaps; and
wherein the band flaps on both sides of the first support portion are connected to each other, and the third band flaps on both sides of the base portion are connected to each other, thereby forming respective bands.

2. The blank of claim 1, further comprising a second support portion configured to be disposed adjacent to the first support portion in a direction identical to that of the first support portion and to have a structure identical to that of the first support portion, side flaps, and band flaps.

3. A blank for fabrication of disposable food or waste tongs, the blank comprising:
a trapezoidal support portion, and a cover portion configured to be symmetrical to the support portion with respect to a fold line;
wherein a first band flap is formed above the cover portion with a central fold line and both side cut lines as boundaries;
wherein second band flaps are formed on both sides of the cover portion with cut lines and a fold line as continuous boundaries; and
wherein fold lines are formed on both sides of the first band flap, and fold lines are formed in lower portions of both sides of the second band flap, thereby forming a first band and a second band.

4. Disposable food or waste tongs fabricated using the blank set forth in claim 1.

5. Disposable food or waste tongs fabricated using the blank set forth in claim 2.

6. Disposable food or waste tongs fabricated using the blank set forth in claim 3.

7. Disposable food or waste tongs, comprising:
a first thimble configured to provide a space adapted to receive a finger, and a third thimble located in a direction opposite to the first thimble;
wherein each of the thimbles has a trapezoidal shape whose width decreases toward a front end thereof when viewed in a plan view and has a side whose height increases in an inward from the front end;
wherein a first band is formed to surround an outside of a rear portion of the first thimble, and a third band is formed to surround an outside of a rear portion of the third thimble; and
wherein extension portions configured to support lower portions of fingers or a palm are formed adjacent to the first thimble and the third thimble, respectively.

8. The disposable food or waste tongs of claim 7, wherein a second band is formed behind the first band of the first thimble, a second band is formed behind the third band of the third thimble, and ventilation openings are formed through sides of the first and third thimbles.

9. The disposable food or waste tongs of claim 7, further comprising a second thimble configured to be identical to the first thimble and to be disposed adjacent to the first thimble in a direction identical to a direction in which the first thimble is disposed.

10. The disposable food or waste tongs of claim 8, further comprising a second thimble configured to be identical to the first thimble and to be disposed adjacent to the first thimble in a direction identical to a direction in which the first thimble is disposed.

11. The disposable food or waste tongs of claim 7, further comprising guides formed on both sides of the extension portions adjacent to the first and third thimbles and configured to support and guide fingers.

12. The disposable food or waste tongs of claim 8, further comprising guides formed on both sides of the extension portions adjacent to the first and third thimbles and configured to support and guide fingers.
